(19) United States
(12) Patent Application Publication
(10) Pub. No.: US 2024/0403056 A1
(43) Pub. Date: Dec. 5, 2024

(54) SHADER LAUNCH SCHEDULING OPTIMIZATION

(71) Applicant: ADVANCED MICRO DEVICES, INC., Santa Clara, CA (US)

(72) Inventor: Wei Ye, Shanghai (CN)

(21) Appl. No.: 18/205,699

(22) Filed: Jun. 5, 2023

(51) Int. Cl. G06F 9/38; G06F 9/48

(52) U.S. Cl. CPC G06F 9/3804; G06F 9/3836; G06F 9/38885; G06F 9/4881

(57) ABSTRACT

A processing system is configured to implement techniques for dynamically selecting an order for executing operations of different branches in a set of branch instructions. In response to receiving the set of branch instructions, the processing system identifies whether a first branch instruction of the set of branch instructions is associated with a first latency value that meets (i.e., equals or exceeds) a latency threshold. Based on the first latency value meeting the latency threshold, the processing system executes operations associated with a second branch instruction of the set of branch instructions prior to executing operations associated with the first branch instruction.

### BACKGROUND

To execute instructions associated with an application such as a shader program, processing systems may include one or more processors with compute units that execute the instructions in waves (also referred to as wavefronts) of operations. In some cases, each workgroup includes a plurality of wavefronts that are broken down by the processing system into hardware schedulable groups of threads to be executed by single instruction, multiple data (SIMD) lanes in the compute unit hardware using a common instruction set. A processor such as an accelerated processing unit (APU) may therefore include compute units that execute the threads of a wavefront based on the same instruction, albeit with different data sets. In some cases, the wavefronts include branch instructions to redirect (or “branch”) a program flow to an instruction at an address indicated by the branch instruction. However, these branch instructions sometimes create thread divergence, which occurs when two threads of the same wavefront diverge in their execution. Conventional methods to account for thread divergence require longer wavefront processing times, thereby increasing the time for executing the application. In some situations, wavefront processing times are further increased when a particular branch instruction triggers a high latency memory request, e.g., a fetch operation to a dynamic random access memory (DRAM) external to the APU. These longer wavefront processing times decrease the performance and efficiency of the processing system.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a diagram of a processing system implementing dynamic selection of the execution order of branch instructions in a set of branch instructions, in accordance with some embodiments.

FIG. 2 is a diagram of an example processor core configured to implement dynamic selection of the execution order of branch instructions in a set of branch instructions, in accordance with some embodiments.

FIG. 3 is a diagram of a device illustrating additional details of the processor core of FIG. 2 to implement dynamic selection of the execution order of branch instructions in a set of branch instructions, in accordance with some embodiments.

FIG. 4 is a flow diagram of an example method for implementing dynamic selection of the execution order of branch instructions in a set of branch instructions, in accordance with some embodiments.

FIG. 5 is another flow diagram of an example method for implementing dynamic selection of the execution order of branch instructions in a set of branch instructions, in accordance with some embodiments.

### DETAILED DESCRIPTION

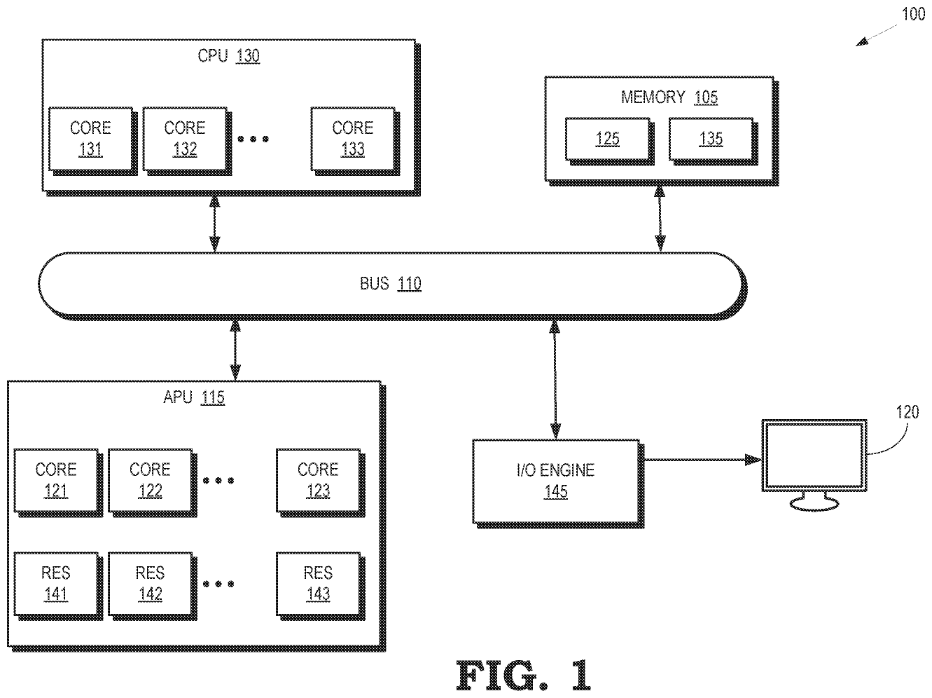

Conventional approaches to avoid or minimize thread divergence created by branch instructions (e.g., if else instructions) in a wavefront include using an execution mask which serializes each branch instruction's execution in the compute unit hardware of the APU. For example, in the case of a wavefront with if else branch instructions (and thus two branch instructions), an execution mask causes a first group of threads in the wavefront to first execute operations associated with the first branch instruction (i.e., the if branch instruction). Once this is finished, the execution mask is modified to cause a second group of threads in the wavefront to execute operations associated with the second branch instruction (i.e., the else branch instruction). In case the if branch instruction includes a memory request with a long latency time (e.g., an instruction with an operation code for a memory request that is associated with longer memory access times such as a buffer_load or image_sample operation), the APU's execution of the whole wavefront is delayed since the APU waits until the requested data is fetched to execute the if branch instruction before the APU executes operations for the wavefront's other branch instructions (i.e., the else instruction). FIGS. 1-5 provide techniques and systems that implement a collaboration between a compiler at a memory associated with the APU and the APU's scheduler to dynamically select, based on the latency associated with the branch instructions, the order of execution of the branch instructions. For example, in some embodiments the APU scheduler schedules the second branch of the branch instructions of the wavefront if the first branch instruction of the wavefront is associated with a longer latency. This reduces the overall wavefront processing time, thereby increasing the APU's arithmetic logic unit (ALU) issue rate and improving overall APU performance.

To illustrate, in some embodiments a compiler in a memory utilizes an application's program code stored in the memory to compile instructions and forwards the compiled instructions to a processing system such as an APU for executing operations of the compiled instructions. In some embodiments, the instructions include a set of branch instructions including a first branch instruction (e.g., if branch) and a second branch instruction (e.g., else branch). The compiler is configured to identify whether the first branch instruction is associated with a latency value that meets (i.e., equals or exceeds) a latency threshold. In some aspects, the latency value is associated with the time to execute one or more memory requests in the first branch instruction. For example, the latency value is related to the number of memory requests in the branch instruction and the duration to execute the memory requests using microarchitecture analysis. If this duration exceeds a duration of the latency threshold, the compiler inserts an indication with the first branch instruction to indicate that executing operations associated with the first branch instruction are to be scheduled after executing operations associated with the second branch instruction while the memory request of the first branch instruction is being performed. The compiler then forwards the set of branch instructions to a scheduler in the APU. The APU's scheduler is configured to receive the set of branch instructions from the compiler and generate wavefronts for executing operations associated with the set of branch instructions at compute units in the APU. For example, the scheduler generates wavefronts for executing ALU operations in SIMD lanes in the compute units. Based on the indication inserted by the compiler, the sr identifies that the first branch instruction includes a memory request with a longer latency. As such, the scheduler issues a wavefront in which the operations associated with the second branch instruction are executed prior to operations of the first branch instruction by changing the context status (e.g., program counter, execution mask) to the second branch instruction. For example, the scheduler saves the first branch instruction's context status (e.g., the first branch instruction's program counter or execution mask), and then switches the context status to trigger execution of the second branch instruction's operations. After the second branch instruction's operations are executed by the compute units, the scheduler marks the second branch instruction's execution status which is later used for convergence once the first branch instruction's operations are executed, and then restores the first branch instruction's context and proceeds to execute the first branch instruction's operations. In this manner, the operations of the second branch instruction are executed prior to the operations of the first branch instruction since the second branch instructions are executed while the memory request of the first branch instruction is being performed. Once the operations associated with the second branch instruction are executed, the scheduler initiates the execution of operations associated with the first branch instruction since, at this point, the memory request of the first branch instruction has at least partially been performed. Accordingly, this reduces the wavefront's processing time and increases the APU's issue rate, thereby improving APU performance.

While the above example details a single reordering of the order for executing operations of the set of branch instructions, it should be appreciated that, in some embodiments, this reordering is performed additional times as needed to streamline the wavefront's overall processing time. For example, in some embodiments, after executing operations of the second branch instruction for a first period of time, the second branch instruction issues a similar memory request as issued in the first branch instruction. And similar to the case described with respect to the first branch instruction, the compiler will also have inserted an indication in the second branch instruction to indicate the longer latency request in the second branch instruction. At this point, the APU pauses a program counter associated with the second branch instruction to stop operations associated with the second branch instruction and initiate a program counter associated with the first branch instruction to start executing operations of the first branch instruction. As such, the APU executes operations of the first branch instruction while waiting for the data to be retrieved in response to the memory request for the second branch instruction. Accordingly, the execution of operations of the set of branch instructions is performed in a piecemeal manner based on the waiting times of the memory requests in the set of branch instructions.

In some embodiments, the techniques and systems shown in FIGS. 1-5 consider a set of branch instructions to include multiple branch instructions whose execution order is interchangeable. To this end, the techniques provided herein extract information from an application's program code (e.g., via a compiler in a memory) used to compile the set of branch instructions and dynamically reschedule the order of branch instructions based on whether one or more of the branch instructions is associated with a long latency memory request. By doing so, the techniques of the present disclosure are able to process branch instructions of a wavefront in a faster and more efficient manner than conventional methods that process branch instructions according to the order of the branches (i.e., by executing operations for the first branch instruction to completion prior to initiating the execution of operations for the second branch instruction).

FIG. 1 is a block diagram of a processing system 100 implementing dynamic selection of the execution order of branch instructions in a set of branch instructions, according to some embodiments. The processing system 100 includes or has access to a memory 105 or other storage component implemented using a non-transitory computer-readable medium, for example, a dynamic random-access memory (DRAM). However, in embodiments, the memory 105 is implemented using other types of memory including, for example, static random-access memory (SRAM), nonvolatile RAM, and the like. According to embodiments, the memory 105 includes an external memory implemented external to the processing units implemented in the processing system 100. The processing system 100 also includes a bus 110 to support communication between entities implemented in the processing system 100, such as the memory 105. Some embodiments of the processing system 100 include other buses, bridges, switches, routers, and the like, which are not shown in FIG. 1 in the interest of clarity.

The techniques described herein are, in different embodiments, employed at least in part at accelerated processing unit (APU) 115 (also referred to as accelerated processor). The APU 115 includes, for example, any of a variety of parallel processors, vector processors, coprocessors, graphics processing units (GPUs), general-purpose GPUs (GPGPUs), non-scalar processors, highly parallel processors, artificial intelligence (AI) processors, inference engines, machine learning processors, other multithreaded processing units, scalar processors, serial processors, or any combination thereof. In some embodiments, the APU 115 renders images according to one or more applications 135 (e.g., shader programs) for presentation on a display 120. For example, the APU 115 renders objects (e.g., groups of primitives) according to one or more shader programs to produce values of pixels that are provided to the display 120, which uses the pixel values to display an image that represents the rendered objects. To render the objects, the APU 115 implements a plurality of processor cores 121 to 123 that execute instructions concurrently or in parallel from, for example, one or more applications 135. For example, the APU 115 executes instructions from a shader program, raytracing program, graphics pipeline, or both using a plurality of processor cores 121 to 123 to render one or more objects. Though in the example implementation illustrated in FIG. 1, three processor cores (121 to 123) are presented representing an N number of cores, the number of processor cores 121 to 123 implemented in the APU 115 is a matter of design choice. As such, in other implementations, the APU 115 can include any number of processor cores 121 to 123. Some implementations of the APU 115 are used for general-purpose computing. The APU 115 executes instructions such as program code 125 (e.g., shader code, raytracing code) for one or more applications 135 (e.g., shader programs, raytracing programs) stored in the memory 105, and the APU 115 stores information in the memory 105 such as the results of the executed instruction.

In some embodiments, the instructions in program code 125 (e.g., shader code) from one or more applications 135 (e.g., shader programs) defined one or more work items (e.g., functions) each identifying, for example, one or more operations to be performed, a size of one or more workgroups (e.g., group of work items), or both. Additionally, in embodiments, processing system 100 groups such work items into one or more workgroups based on, for example, predetermined values, the types of operations identified in the work items, architecture of the APU 115, availability of compute unit resources, or any combination thereof. To perform a workgroup (e.g., group of work items), one or more processor cores 121 to 123 of APU 115 operate as one or more compute units each configured to launch one or more wavefronts (e.g., waves) to perform a workgroup. To this end, each compute unit includes one or more single instruction, multiple data (SIMD) units each including a plurality of lanes configured, for example, to perform a same operation on different data sets as indicated in one or instructions received from an application 135. As an example, each SIMD unit includes a plurality of arithmetic logic units (ALUs) that each perform a same operation on a plurality of data sets. In embodiments, one or more SIMD units of a compute unit include a vector SIMD unit (e.g., a SIMD unit including one or more vector ALUs), a scalar SIMD unit (e.g., a SIMD unit including one or more scalar ALUs), or both. According to embodiments, each compute unit is configured to concurrently launch one or more waves. For example, one or more lanes of each SIMD unit of a compute unit are configured to concurrently perform the operations for one or more waves. Each portion (e.g., lanes) of a SIMD unit configured to perform operations for a wave is also referred to herein, for example, as a waveslot. In this way, a compute unit has a number of waveslots (e.g., portions of SIMD units) each configured to concurrently perform one or more waves (e.g., perform operations for one or more waves).

Further, to support the SIMD units, each processor core 121 to 123 includes or is otherwise coupled to one or more respective sets of compute unit resources (RES) 141 to 143. For example, each compute unit of a processor core 121 to 123 includes or is otherwise coupled to a respective set of compute unit resources 141 to 143. These compute unit resources 141 to 143, for example, are configured to store values, register files, operands, instructions, variables, result data (e.g., data resulting from the performance of one or more operations), flags, or any combination thereof necessary for, aiding in, or helpful for performing one or more operations indicated in one or more instructions from an application 135 (e.g., in a workgroup based on the instructions from an application 135). Further, such compute unit resources 141 to 143 include, for example, one or more registers (e.g., vector registers, scalar registers), local data shares, scratch memory, or any combination thereof. According to embodiments, one or more compute unit resources 141 to 143 are included in a respective compute unit, one or more compute unit resources 141 to 143 are shared between two or more compute units, or both. Though the example embodiment illustrated in FIG. 1 presents processing system 100 with three sets of compute unit resources (141 to 143) for three respective processor cores 121 to 123, in other embodiments, processing system 100 has any number of sets of compute unit resources 141 to 143 for one or more respective processor cores 121 to 123.

In embodiments, processing system 100 is configured to allocate one or more portions of one or more compute unit resources 141 to 143 (e.g., registers, local data shares, scratch memory) to one or more waves of a workgroup (e.g., portions of the SIMD units of one or more compute units performing the operations for the waves). To this end, in embodiments, the APU 115 includes a command processor (also referred to as a “scheduler”, not shown for clarity) including hardware-based circuitry, software-based circuitry, or both configured to issue respective workgroups (e.g., as commands, instructions, or both) to one or more compute units of one or more processor cores 121 to 123. In response to the workgroups being issued to one or more compute units, fixed-function hardware (e.g., software-based circuitry, hardware-based circuitry or both configured to implement graphics pipeline stages, tessellation stages, rasterization stages, or any combination thereof) of the APU 115 allocates one or more portions of one or more compute unit resources 141 to 143 to the waves of the workgroups to be launched on the compute units (e.g., to the lanes of the SIMD units to perform operations for the waves) based on the types of operations identified in the workloads, the availability of compute unit resources 141 to 143, priorities associated with the workloads, or any combination thereof. For example, fixed-function hardware of the APU 115 (e.g., via a serial peripheral interface (SPI)) programs a base register with a base address to allocate one or more physical registers (e.g., vector registers, scalar registers) of a set of compute unit resources 141 to 143 to one or more waves to be launched on a compute unit. In response to receiving an instruction to launch a wave, a compute unit of a processor core 121 to 123 determines the physical registers (e.g., vector registers, scalar registers) of a set of compute unit resources 141 to 143 allocated to the waves to be launched based on the base address in the base register.

In some cases, the APU 115 receives a set of branch instructions associated with executing operations based on program code 125 for one or more applications 135. For example, a compiler (not shown in FIG. 1) in the memory 105 generates a set of branch instructions based on the program code 125. In some embodiments, the set of branch instructions includes two branch instructions. For example, the set of branch instructions is an if else instruction, where the if instruction is the first branch instruction and the else branch instruction is the second branch instruction. Upon generating the set of branch instructions based on program code 125, the compiler identifies whether the first branch instruction is associated with a latency value that meets (i.e., equals or exceeds) a latency threshold. In some aspects, the latency value is associated with a duration to execute a memory request (e.g., to a DRAM to fetch data back to the APU 115) in the first branch instruction. If this duration exceeds a duration of the latency threshold, the compiler inserts an indication with the first branch instruction to indicate that executing operations associated with the first branch instruction are to be yielded to (e.g., scheduled after) executing operations associated with the second branch instruction while the memory request of the first branch instruction is being performed. The compiler then forwards the set of branch instructions to a scheduler (not shown in FIG. 1) in the APU 115.

In some embodiments, the APU's scheduler is configured to receive the set of branch instructions from the compiler and generate wavefronts for executing operations associated with the set of branch instructions at compute units in the processor cores 121 to 123 of the APU 115. Based on the indication inserted by the compiler, the scheduler identifies that the first branch instruction includes a memory request with a longer latency. As such, the scheduler issues a wavefront in which the operations associated with the second branch instruction are executed prior to operations of the first branch instruction by changing the initial context status (e.g., program counter, execution mask) to the second branch instruction. In some embodiments, the scheduler issues a wavefront as it typically would issue for the set of branch instructions, albeit with a modification in which the context status is switched so that operations of the second branch instruction are executed first. In this manner, the compute units in the processor cores 121 to 123 execute operations of the second branch instruction prior to the operations of the first branch instruction since the second branch instructions are executed while the memory request of the first branch instruction is being performed. Once the compute units in the processor cores 121 to 123 execute the operations associated with the second branch instruction, the scheduler initiates the execution of operations associated with the first branch instruction since, at this point, the memory request of the first branch instruction has at least partially been performed. Accordingly, this reduces the wavefront's processing time and increases the issue rate of the APU 115, thereby improving APU performance.

In some embodiments, the set of branch instructions is compiled by a compiler of another processing system. In this case, the set of branch instructions wouldn't be received from the compiler of the same processing system (at least directly), but instead would be stored in a memory. In these cases, the compiled instructions include metadata or some other indication as to the latency of the branch instructions.

The processing system 100 also includes a central processing unit (CPU) 130 that is connected to the bus 110 and therefore communicates with the APU 115 and the memory 105 via the bus 112. The CPU 130 implements a plurality of processor cores 131 to 133 that execute instructions concurrently or in parallel. In embodiments, one or more of the processor cores 131 to 133 each operate as one or more compute units (e.g., SIMD units) that perform the same operation on different data sets. Though in the example embodiment illustrated in FIG. 1, three processor cores (131 to 133) are presented representing an M number of cores, the number of processor cores 131 to 133 implemented in the CPU 130 is a matter of design choice. As such, in other embodiments, the CPU 130 can include any number of processor cores 131 to 133. In some embodiments, the CPU 130 and the APU 115 have an equal number of processor cores, while in other embodiments, the CPU 130 and the APU 115 have a different number of processor cores. The processor cores 131 to 133 execute instructions such as program code 125 stored in the memory 105 and the CPU 130 stores information in the memory 105 such as the results of the executed instructions. The CPU 130 is also able to initiate graphics processing by issuing draw calls to the APU 115. In embodiments, the CPU 130 implements multiple processor cores (not shown in FIG. 1 in the interest of clarity) that execute instructions concurrently or in parallel.

An input/output (I/O) engine 145 includes hardware and software to handle input or output operations associated with the display 120, as well as other elements of the processing system 100 such as keyboards, mice, printers, external disks, and the like. The I/O engine 145 is coupled to the bus 112 so that the I/O engine 118 communicates with the memory 105, the APU 115, or the CPU 130.

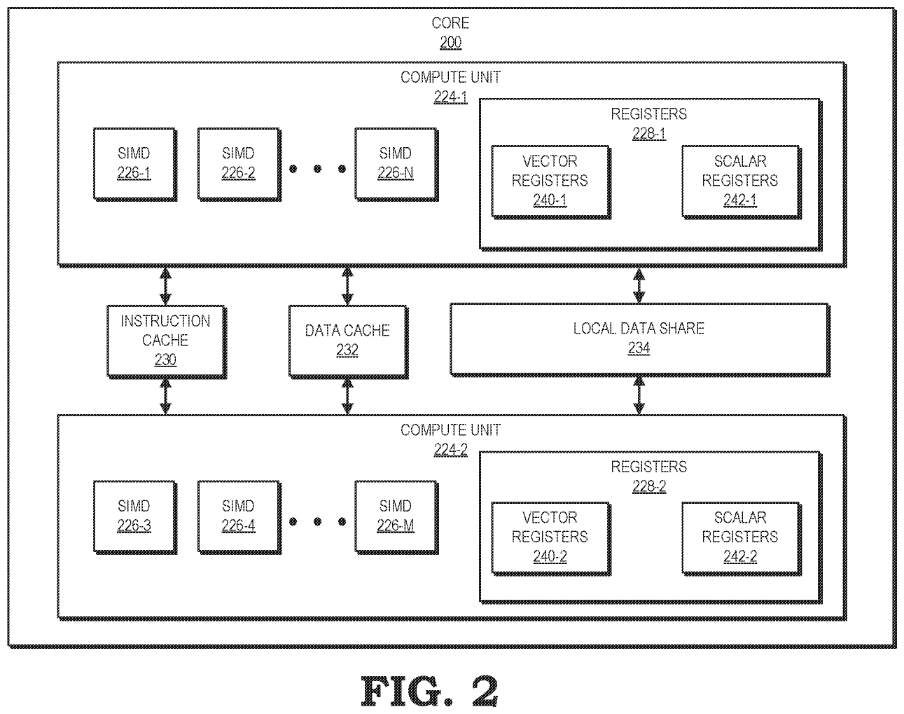

FIG. 2 shows an example processor core 200 configured for implementing dynamic selection of the execution order of branch instructions in a set of branch instructions, according to some embodiments. In some embodiments, processor core 200 is similar to or the same as processor cores 121 to 123 in FIG. 1 and includes two compute units 224 configured to perform one or more workgroups (e.g., group of work items) indicated in program code 125 from an application 135 (e.g., shader program). Though the example embodiment of FIG. 2 presents processor core 200 having two compute units (224-1, 224-2), in other embodiments, processor core 200 has any number of compute units 224. To perform a workgroup indicated in program code 125, each compute unit 224 is configured to launch one or more waves (e.g., wavefronts) to perform one or more functions, operations, or both indicated in the workgroup (e.g., indicated in the program code 125). To this end, each compute unit 224 includes one or more SIMD units 226 (e.g., vector SIMD units, vector SIMD units) each configured to perform one or more operations for one or more functions identified in a workgroup in one or more waves. That is to say, at least a portion of each SIMD unit 226 is configured to launch a wave using one or more lanes of the SIMD unit 226 to perform one or more operations for one or more functions identified in a workgroup. Though the example embodiment of FIG. 2 presents compute unit 224-1 having three SIMD units (226-1, 226-2, 226-N) representing an N number of SIMD units and compute unit 224-2 having three SIMD units (226-3, 226-4, 226-M) representing an M number of SIMD units, in other embodiments, each compute unit 224 includes any number of SIMD units 226.

To aid SIMD units 226 in performing one or more operations for a workgroup, each compute unit 224 includes or is otherwise connected to instruction cache 230. For example, in embodiments, each compute unit 224-1, 224-2 includes a respective instruction cache 230 while in other embodiments, one or more instruction caches 230 are connected to each compute unit 224-1, 224-2 (e.g., are shared by the compute units 224). Instruction cache 230, for example, includes a memory (e.g., SRAM) configured to store one or more instructions necessary for, aiding in, or helpful for performing one or more operations of a workgroup (e.g., one or more operations for the waves of a workgroup). In embodiments, instruction cache 230 is shared by each wave (e.g., lanes of the SIMD units performing operations for the wave) launched by one or more compute units. For example, instruction cache 230 is shared by the waves launched on compute units 224-1, 224-2. Similarly, each compute unit 224 also includes or is otherwise connected to data cache 232. For example, in embodiments, each compute unit 224-1, 224-2 includes a respective data cache 232 while in other embodiments, one or more data caches 232 are connected to each compute unit 224-1, 224-2 (e.g., are shared by the compute units 224). Data cache 232, for example, includes a memory (e.g., SRAM) configured to store data (e.g., cache lines) necessary for, aiding in, or helpful for performing one or more operations of a workgroup (e.g., one or more operations for the waves of a workgroup). In embodiments, instruction cache 230 is shared by each wave (e.g., lanes of the SIMD units performing operations for the wave) launched by one or more compute units.

Additionally, to aid SIMD units 226 in performing one or more operations for a workgroup, processor core 200 includes or is otherwise connected to a set of compute unit resources, similar to or the same as a set of compute unit resources (RES) 141 to 143 of FIG. 1, configured to, for example, store values, register files, operands, instructions, variables, result data (e.g., data resulting from the performance of one or more operations), flags, or any combination thereof necessary for, aiding in, or helpful for performing one or more operations indicated in a workgroup received by the processor core 200. Such processing resources, for example, include registers 228, local data share 234, or both. For example, each compute unit 224 includes or is otherwise connected to a set of registers 228 configured to store values, operands, resulting data (e.g., data resulting from the performance of one or more operations, register files, or any combination thereof) necessary for, aiding in, or helpful for the performance of one or more operations for a workgroup. In embodiments, a set of registers 228 includes one or more vector registers 240 configured to store data (e.g., operands, values) necessary for, aiding in, or helpful for the performance of one or more operations by, for example, a vector SIMD unit 226. Such vector registers 240, for example, are shared by one or more lanes of a SIMD unit 226 performing operations for one or more waves of a workgroup. According to embodiments, one or more vector registers 240 are allocated to one or more lanes of a SIMD unit 226 performing operations for a same wave, one or more vector registers are allocated to one or more lanes of a SIMD unit 226 performing operation for two or more waves (e.g., one or more vector registers are allocated such that the vector registers are shared by the lanes of a SIMD unit 226 performing operations for two or more waves), or both. A set of registers 228, in embodiments, additionally or alternatively includes one or more scalar registers 242 configured to store data (e.g., operands, values) necessary for, aiding in, or helpful for the performance of one or more operations by, for example, a scalar SIMD unit 226. Though the example embodiment presented in FIG. 2 provides a first compute unit 224-1 having one set of registers 228-1 (e.g., including vector registers 240-1 and scalar registers 242-1) and a second compute unit having one set of registers 228-2 (e.g., including vector registers 240-2 and scalar registers 242-2), in other embodiments, each compute unit 224 has any number of sets of registers 228 each including any number of vector registers 240, scalar registers 242, or both.

Further, each compute unit 224 includes or is otherwise connected to local data share 234. Local data share 234 includes a memory (e.g., SRAM) shared across each SIMD unit 226 across one or more compute units. That is to say, local data share 234 is shared across each wave executing on one or more compute units 224. For example, in the example embodiment presented in FIG. 2, local data share 234 is shared across each SIMD unit 226 of compute unit 224-1 and compute unit 224-2 such that local data share 234 is shared across the waves launched on compute unit 224-1 and compute unit 224-2. In embodiments, local data share 234 is configured to store results (e.g., data resulting from the performance of one or more operations by one or more SIMD units 226), operands, register files, or any combination thereof necessary for, aiding in, or helpful for the performance of one or more operations by one or more SIMD units 226. As an example, local data share 234 is used as a scratch memory to store results necessary for, aiding in, or helpful for the performance of one or more operations by one or more SIMD units 226. Additionally, because local data share 234 is shared across each SIMD unit 226 and one or more compute units (e.g., shared across the waves executing on one or more compute units 224), local data share 234 allows for data to be shared across the SIMD units 226 of one or more compute units 224 (e.g., across the waves executing on the compute units 224). For example, results determined from the performance of an operation for a first wave by, for example, one or more lanes of a SIMD unit 226, are stored in local data share 234. Such results are then made available to one or more operations of one or more other waves executed on, for example, one or more other lanes of a same or different SIMD unit 226. According to embodiments, processing system 100 is configured to allocate at least a portion of local data share 234 to one or more waves of a workgroup to be performed on one or more compute units 224. For example, processing system 100 defines one or more respective portions (e.g., in kilobytes) of local data share 234 that are to be visible to one or more waves of a workgroup to be performed on one or more compute units 224 (e.g., visible to one or more lanes of one or more SIMD units 226 configured to perform one or more waves of a workgroup).

In some embodiments, one or more compute units 224 are configured to execute operations associated with a set of branch instructions including a first branch instruction and a second branch instruction that are retrieved from an instruction cache 230, for example. In response to wavefronts issued by a scheduler (not shown in FIG. 2), in some embodiments, one or more of the compute units 224 pre-fetch instructions for a second branch instruction based on a first branch instruction being identified as having one or more memory requests with a latency value that meets (i.e., equals or exceeds) a latency threshold. For example, the latency value is related to the number of memory requests and the total duration to execute the memory requests. Based on such an identification, one or more of the compute units 224 execute operations associated with the second branch instruction via the SIMD units 226 while the memory request for the first branch instruction is being executed by changing the context status (e.g., program counter, execution mask) to execute operations associated with the second branch instruction. Then, after the SIMD units 226 finish executing the operations of the second branch instruction, one or more of compute units 224 initiate executing the operations of the first branch instruction based on the data received in response to the memory request. This streamlines the execution of the operations of the set of branch instructions, thereby decreasing wavefront processing times and improving APU performance.

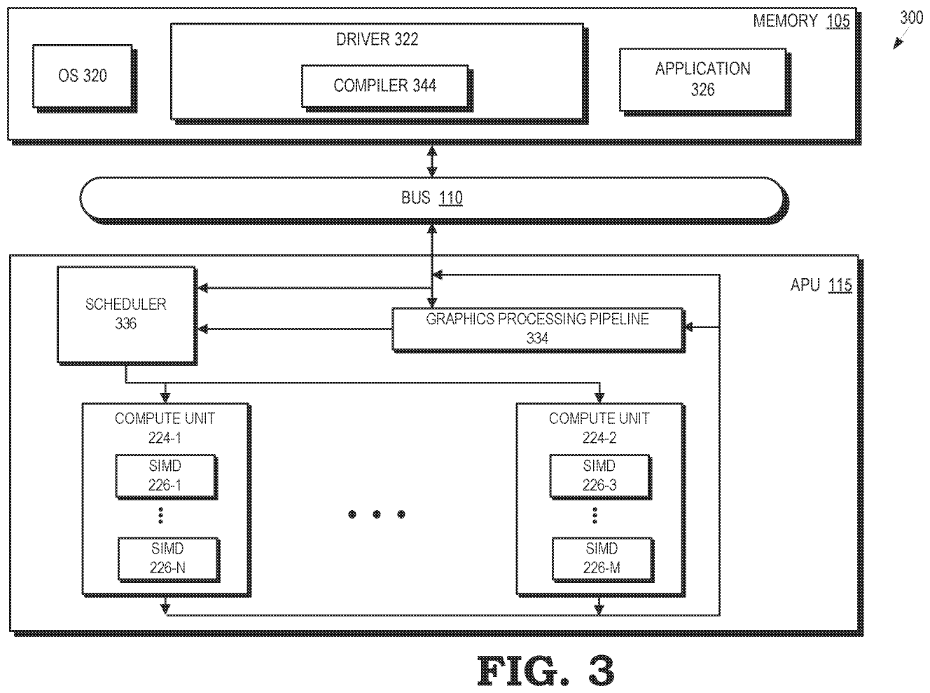

FIG. 3 shows an example device 300 for implementing dynamic selection of the execution order of branch instructions in a set of branch instructions in an APU such as APU 115 in FIG. 1, according to some embodiments. Furthermore, the compute units 224-1 to 224-2 of the APU 115 shown in FIG. 3 are the same or similar to one or both of the compute units 224-1 or 224-2 shown in FIG. 2.

In some embodiments, the memory 105 includes one or more control logic modules for executing by the CPU 130 or the APU 115. For example, the control logic modules include an operating system (OS) 320, a driver 322, and application 326. These control logic modules control various features related to the operation of CPU 130 or the APU 115. For example, the OS 320 communicates with hardware and provides an interface to the hardware for other software executing on the CPU 130. The driver 322 controls operation of the APU 115 by, for example, providing an application programming interface (“API”) to software, such as application 326, executing on the CPU 130 to access various functionalities of the APU 115. In some implementations, the driver 322 includes a compiler 344 that compiles sets of instructions for execution by processing components such as the SIMD units 226-1 to 226-N and 226-3 to 226-M of the APU 115.

In some embodiments, the APU 115 includes compute units 224 that include one or more SIMD units 226 that perform operations at the request of the CPU 130 in a parallel manner. In some embodiments, this means that the SIMD units 226 share a single program control flow unit and program counter and thus execute the same program but are able to execute that program with different data. In one example, each SIMD unit 226 includes sixteen lanes, where each lane executes the same instruction at the same time as the other lanes in the SIMD unit 226 but executes that instruction with different data. Lanes can be switched off with predication if not all lanes need to execute a given instruction. Predication can also be used to execute threads with divergent control flow. More specifically, for wavefronts with conditional branches or other instructions where control flow is based on calculations performed by an individual lane, predication of lanes corresponding to control flow paths not currently being executed, and serial execution of different control flow paths, allows for arbitrary control flow.

In some embodiments, shader programs to be executed on the APU 115 are compiled from source code into instructions which includes a set of branch instructions. In some embodiments, such compilation occurs in one or more stages by one or more compilers 344 (one shown for clarity). For example, an initial compiler of the one or more compilers 344 compiles the shader programs to an intermediate format and, as the application 326 is being loaded for execution, a final compiler of the one or more compilers 344 compiles the shader programs to a final format with a set of branch instructions. In some implementations, the compiler 344 is embodied as a software program that executes on a processor such as CPU 130.

In some embodiments, prior to transmitting a set of branch instructions to a scheduler 336 of the APU 115, the compiler 344 identifies a first branch instruction in the set of branch instructions as having a memory request associated with a long latency time. In response, the compiler 344 inserts an indication in the set of instructions to signal to the scheduler 336 that executing operations associated with the first branch instruction are to be yielded to executing operations associated with a second branch instruction of the set of branch instructions while the memory request of the first branch instruction is being performed. In some embodiments, the set of branch instructions is related to, for example, executing one or more shader stages of a graphics processing pipeline 334. The scheduler 336 receives the set of branch instructions along with the indication from the compiler 344 and generates wavefronts for execution on the compute units 224 by changing the context status accordingly, e.g., instructs the compute units 224 to executes operations associated with the second branch instruction while the memory request of the first branch instruction is being performed. For example, in some embodiments, the scheduler 336 saves the first branch instruction's context status (e.g., the first branch instruction's program counter or execution mask), and then switches the context status to trigger execution of the second branch instruction's operations. After the second branch instruction's operations are executed by the compute units 224-1 to 224-2, the scheduler 336 marks the second branch instruction's execution status which is later used for convergence once the first branch instruction's operations are executed, and then restores the first branch instruction's context. Once the first branch instruction's context is restored, the compute units 224-1 to 224-2 proceed to execute the first branch instruction's operations.

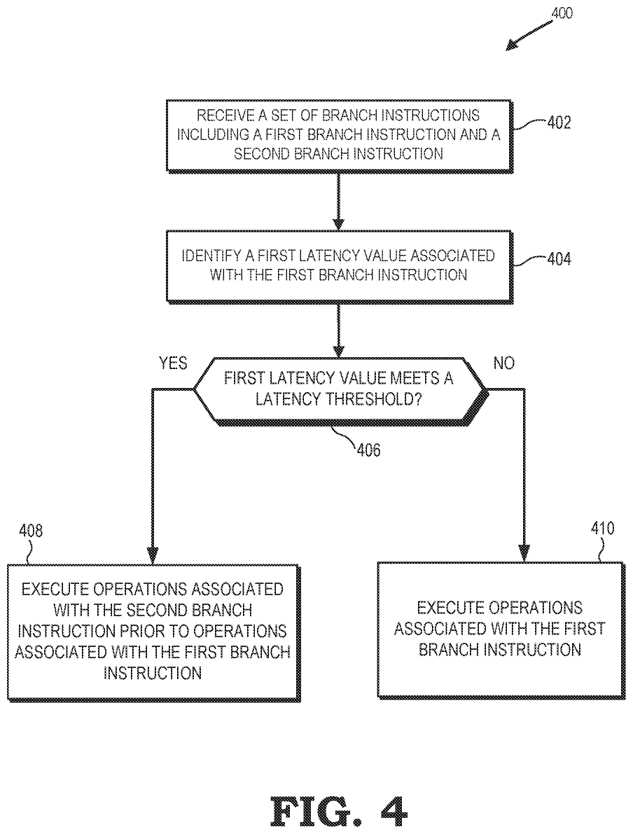

FIG. 4 shows an example method 400 for implementing dynamic selection of the execution order of branch instructions in a set of branch instructions in an APU such as APU 115 in FIG. 1 or 3, according to some embodiments.

At 402, the method includes an APU, such as APU 115, receiving a set of branch instructions including a first branch instruction and a second branch instruction. For example, the set of branch instructions is an if else set of instructions, where the if instruction is the first branch instruction and the else instruction is the second branch instruction. In some embodiments, the set of instructions received by the APU, such as APU 115, is transmitted by a compiler, such as compiler 344.

At 404, the method includes a compiler, such as compiler 344, identifying a first latency value associated with the first branch instruction. Although shown as being after 402, in some embodiments, step 404 is performed concurrently or prior to 402. In some embodiments, the compiler utilizes an application's program code stored in the memory to compile instructions for executing operations of the application at an APU. In some embodiments, the instructions include a set of branch instructions including the first branch instruction (e.g., if branch instruction) and the second branch instruction (e.g., else branch instruction). For example, in some embodiments, the first latency value is related to an instruction with an operation code for a memory request that is associated with longer memory access times such as a buffer load operation (e.g., buffer_load) or an image 34, operation (e.g., image_sample).

At 406, the method includes an APU, such as APU 115, determining whether the first latency value meets (i.e., equals or exceeds) a threshold. In some embodiments, this determination is facilitated by the compiler, such as compiler 344, inserting an indication in the set of branch instructions transmitted to the APU. In this scenario, the compiler is configured to identify whether the first branch instruction is associated with a latency value that meets a latency threshold. For example, the first latency value is associated with a duration to execute a memory request in the first branch instruction. If this duration exceeds a duration of the latency threshold, the compiler inserts an indication with the first branch instruction to signal as much to a scheduling component of the APU, such as scheduler 336 of APU 115.

At 408, the method includes the APU, such as APU 115, executing operations associated with the second branch instruction prior to executing operations associated with the first branch instruction based on the first branch instruction having a latency at or above the specified threshold. For example, these operations include ALU operations associated with the first and second branch instructions. In some embodiments, the APU 115 triggers this feature based on the compiler's insertion of the indication in the set of branch instructions.

In the alternative to 408, based on the first branch instruction having a latency failing to meet the specified threshold, the method includes the APU, such as APU 115, executing operations associated with the first branch instruction prior to executing operations associated with the second branch instruction.

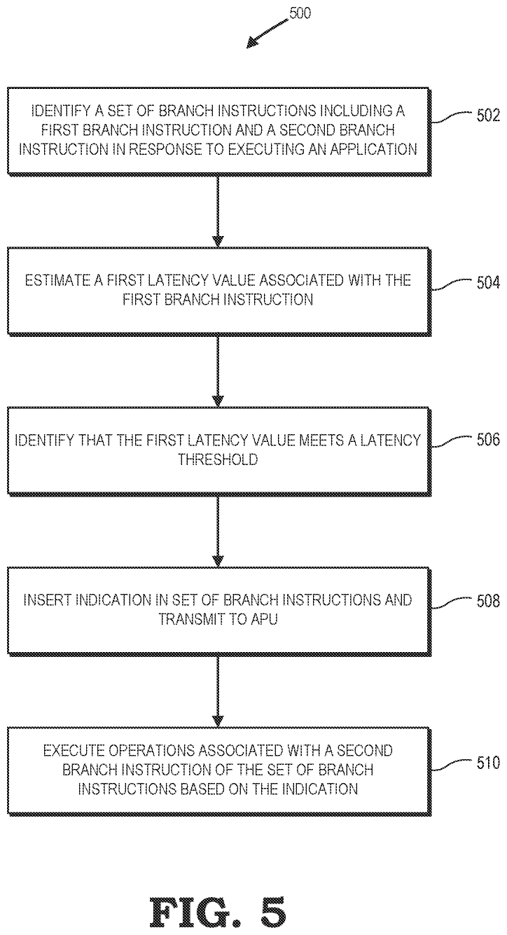

FIG. 5 shows an example method 500 for implementing dynamic selection of the execution order of branch instructions in a set of branch instructions in an APU such as APU 115 in FIG. 1 or 3, according to some embodiments.

At 502, the method includes a compiler, such as compiler 344, identifying a set of branch instructions including a first branch instruction and a second branch instruction in response to executing an application. For example, if the set of branch instructions is an if else set of branch instructions, the first branch is the if branch instruction and the second branch is the else branch instruction.

At 504, the method includes a compiler, such as compiler 344, estimating a first latency value associated with the first branch instruction. For example, in some embodiments, this first latency value is a latency time associated with executing a memory request in the first branch instruction.

At 506, the method includes a compiler, such as compiler 344, identifying that the first latency value meets (i.e., equals or exceeds) a latency threshold. In some embodiments, the first latency value is a duration of a fetch operation associated with a memory request of the first branch instruction, and the latency threshold is based on the duration required to fetch data from a memory in response to the memory request. For example, in some embodiments, the latency threshold is based in part on a second latency value corresponding to a duration of a fetch operation associated with a memory request of the second branch instruction. In this case, the first latency value meeting the latency threshold comprises the first latency value exceeding the second latency value. In some embodiments, the first latency value and/or the latency threshold is related to an instruction with an operation code for a memory request that is associated with longer memory access times such as a buffer load operation (e.g., buffer_load) or an image sample operation (e.g., image_sample).

At 508, the method includes a compiler, such as compiler 344, inserting an indication in the set of branch instructions based on the first latency value meeting the latency threshold, and transmitting the set of branch instructions to an APU, such as APU 115.

At 510, the method includes the APU, such as APU 115, executing operations associated with the second branch instruction of the set of branch instructions based on the indication that the first latency value meets the latency threshold.

In some embodiments, the apparatus and techniques described above are implemented in a system including one or more integrated circuit (IC) devices (also referred to as integrated circuit packages or microchips), such as the processing system configured for implementing dynamic selection of the execution order of branch instructions in a set of branch instructions described above with reference to FIGS. 1-5. Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some embodiments, certain aspects of the techniques described above may implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
in response to receiving a set of branch instructions, identifying whether a first branch instruction of the set of branch instructions is associated with a first latency value that meets a latency threshold; and
executing operations associated with a second branch instruction of the set of branch instructions prior to executing operations associated with the first branch instruction based on the first latency value meeting the latency threshold.

2. The method of claim 1, wherein the first latency value is based on a memory request to an external memory.

3. The method of claim 2, wherein the memory request is a buffer load operation or an image sample operation.

4. The method of claim 1, wherein the identifying that the first branch instruction meets the latency threshold is performed based on an indication from a compiler.

5. The method of claim 1, wherein the first latency value is a duration of a fetch operation associated with one or more memory requests in the first branch instruction, wherein the latency threshold is based on a second latency value associated with the second branch instruction, and wherein the second latency value is a duration of a fetch operation associated with one or more memory requests of the second branch instruction.

6. The method of claim 1, wherein the latency threshold is based on a duration required to fetch data from a memory in response to a memory request.

7. The method of claim 1, wherein executing operations associated with the second branch instruction of the set of branch instructions prior to operations associated with the first branch instruction comprises executing arithmetic logic unit (ALU) operations associated with the second branch instruction prior to ALU operations associated with the first branch instruction.

8. The method of claim 1, wherein the set of branch instructions are included in a wavefront launched by a scheduler in an accelerated processing unit.

9. The method of claim 8, wherein the scheduler receives instructions associated with executing the wavefront from a compiler, wherein the compiler is configured to identify whether the first latency value meets the latency threshold.

10. The method of claim 9, wherein the scheduler schedules the executing of operations associated with the second branch instruction prior to operations associated with the first branch instruction by pausing a program counter associated with the first branch instruction and initiating a program counter associated with the second branch instruction.

11. An accelerated processing unit comprising:
a scheduler to receive a set of branch instructions and identify whether a first branch instruction of the set of branch instructions is associated with a first latency value that meets a latency threshold; and
a plurality of compute units to execute operations associated with a second branch instruction of the set of branch instructions prior to operations associated with the first branch instruction based on the first latency value meeting the latency threshold.

12. The accelerated processing unit of claim 11, wherein the first latency value is based on a memory request to an external memory.

13. The accelerated processing unit of claim 12, wherein the memory request is a buffer load operation or an image sample operation.

14. The accelerated processing unit of claim 11, wherein the first latency value is a duration of a fetch operation associated with one or more memory requests of the first branch instruction, wherein the latency threshold is based on a second latency value associated with the second branch instruction, and wherein the second latency value is a duration of a fetch operation associated with one or more memory requests of the second branch instruction.

15. The accelerated processing unit of claim 11, wherein the latency threshold is based on a duration required to fetch data from a memory in response to a memory request.

16. The accelerated processing unit of claim 11, further comprising:
the scheduler to receive the set of branch instructions from a compiler, where the compiler identifies whether the first branch instruction of the set of branch instructions is associated with the first latency value that meets the latency threshold,
wherein the scheduler instructs the plurality of compute units to execute operations associated with the second branch instruction prior to operations associated with the first branch instruction.

17. The accelerated processing unit of claim 11, further comprising:
an interface to a memory that stores data for executing operations associated with the first branch instruction and data for executing operations associated with the second branch instruction.

18. A processing system comprising:
a memory; and
an accelerated processing unit coupled to the memory and configured to receive a set of branch instructions comprising a first branch instruction and a second branch instruction from the memory, the accelerated processing unit to:
in response to receiving the set of branch instructions, identify whether the first branch instruction is associated with a first latency value that meets a latency threshold; and
execute operations associated with the second branch instruction prior to operations associated with the first branch instruction based on the first latency value meeting the latency threshold.

19. The processing system of claim 18, wherein the first latency value is a duration of a fetch operation associated with a memory request of the first branch instruction.

20. The processing system of claim 18, wherein the latency threshold is based on a second latency value associated with the second branch instruction, and wherein the first latency value meeting the latency threshold comprises the first latency value exceeding the second latency value.
